(19) United States
(12) Patent Application Publication
(10) Pub. No.: US 2002/0023054 A1
(43) Pub. Date: Feb. 21, 2002

(54) Method and system for protecting credit card transactions

(76) Inventor: Kenneth E. Gillespie, Freeport, NY (US)

Correspondence Address: NIXON & VANDERHYE P.C., 1100 North Glebe Road, 8th Floor, Arlington, VA, 22201-4714, US

(21) Appl. No.: 09/833,654

(22) Filed: Apr. 13, 2001

Related U.S. Application Data
(60) Provisional application No. 60/197,005, filed on Apr. 13, 2000.

(51) Int. Cl. G06F 17/60

(52) U.S. Cl. 705/39

(57) ABSTRACT

A method of performing a financial transaction involves a provider of goods or services, a purchaser of goods or services, a credit card issuer that has issued a credit card to the purchaser, and an information clearing center with a private credit card database coupled to a private network. When a transaction is performed between the provider and the purchaser, a further identifier different from the credit card identifier is associated with the purchaser. The purchaser's further identifier—but not said credit card identifier—is communicated to the information clearing center over the Internet. The private credit card database retrieves the purchaser's further identifier and performs a secure mapping between the further identifier and the purchaser's credit card identifier. The purchaser's credit card identifier is then securely communicated from the information clearing center to the credit card issuer. The credit card issuer charges the purchaser's credit card based at least in part on the securely communicated credit card identifier. Since the only transmission of the purchaser's credit card number is from the information clearing center to the credit card issuer via a highly secure connection that cannot be hacked, this information is kept secret so that credit card fraud is avoided.

### BACKGROUND OF THE INVENTION

The Internet has provided a major mechanism for the conduct of commerce, already used by millions of consumers and thousands of companies. E-commerce is growing at explosive rates and now accounts for many billions of dollars in transactions. A large percentage of consumer goods and services sold on the Internet are paid for electronically with credit cards. In the early days of credit cards, credit card purchases were processed relying on authorizations that were confirmed by the written signatures of credit cardholders. As the concept of credit card buying evolved, telephonically initiated purchases began to flow. Vouchers for these purchases started to be prepared by personnel in the employ of the merchants, with the account numbers communicated to them by the purchasers verbally. As transactions moved away from written signature based authorizations, the card issuers experienced new challenges.

### Evolving Problems With Credit Card Transactions

For example, documentation of purchases based on unsigned vouchers is generally not as indisputable as signed vouchers. Cardholders could make a purchase verbally, then declare that they received the wrong merchandise, or even that they hadn't agreed to the purchase at all. To deal with this problem, credit card issuers took steps that included developing policies, revising their credit card agreements, and increasing staffing to handle these kinds of inquiries and complaints.

Opportunities for cardholders to cry “foul” will likely multiply as the volume of e-transactions multiplies. Also, with vast amounts of credit card information transmitted on the Internet, some cardholders will discover new opportunities to “beat” the system for their own purposes. Similarly, the potential for increases in the incidence of misunderstandings that occur when merchants make errors or act improperly will also be enlarged. Problems with credit card theft, fraud, misuse and abuse have always posed a source of substantial expense and inconvenience to the credit card industry, merchants and legal authorities. The Internet has the power to significantly magnify these problems, and to cause serious new concern and fear to consumers. As long as valid credit card information is transmitted in the public domain, it will be vulnerable to illegal interception by criminals. The information is often vulnerable to misuse by its intended recipients, and to illegal access from their storage devices and other records.

Some of the complaints will not be lodged until after unexpected debits appear cardholders' monthly statements. All of the complaints will have to be sorted out and some will require serious investigations. Some will be resolvable and many others will result in costly write-offs. Current laws afford certain protection to cardholders after they report their card stolen, but if their account numbers are stolen they will not be able to report it until they are aware of it. If they don't find out until they receive their monthly statements, serious damage may have already been done to a merchant, a cardholder, a card issuer, or any or all of these.

### Credit Card Agreements: The Cardholders' Interests

Customarily, credit card agreements endeavor to protect the cards' issuers to the maximum extent allowed by law. Many cardholders do not read or understand the agreements they authorize by using their credit cards. Such agreements might, for example, include terms such as “If you permit any person to have access to your card or account number with the authorization to make a charge, you may be liable for all charges made by that person, including charges you may not have intended to be liable for.” It is not unreasonable to assume that to the card issuer “may be responsible” means “will be responsible, unless current law clearly absolves the cardholder of that responsibility.” Other credit card agreements might include terms such as, for example, “Charges include any purchase or cash advance in which you have evidenced an intent to incur a charge, regardless of whether you have signed a charge form.”

### Credit Card Agreements: The Card Issuers' Interests

“Standard” credit card agreements contain a (statutory) clause specifying that cardholders are liable for a maximum of $50.00 in the event of unauthorized use of credit cards. As a result of the proliferation of the Internet, the potential for unauthorized usage of credit cards continues to grow rapidly. As long as valid credit card numbers are transmitted over this public domain, this risk is bound to be increasingly problematic. The number of purchases processed electronically, without signed authorizations or card imprints, is increasing explosively. As this trend continues, discerning unauthorized use from authorized use becomes increasingly difficult. It is well known that security is the largest single concern that exists in connection with the cyberspace infrastructure. Credit cards will not be reported lost by those whose account numbers have been compromised until they become aware of it.

### Credit Card Agreements: Statutory

Credit card agreements often also contain a section titled “Special Rules For Credit Card Purchases”, which reads something like the following:

“If you have a problem with the quality of property or services that you purchased with a credit card, you may have the right not to pay the remaining amount due on the property or services. There are two limitations on this right:

a) You must have made the purchase in your home state, or if not within your home state, within 100 miles of your current mailing address; and

b) The purchase price must have been more than $50.”

The “right not to pay” that a cardholder “may” have, clearly is not granted summarily by the card issuers. Since Internet based merchants often do not publish information about their locations, difficulties resolving these matters are likely to be exacerbated.

### Merchants' Difficulties With Credit Card Sales

Merchants release inventory to buyers every day on the strength of credit card approval codes provided by the credit card issuers. The merchant wishes to avoid “charge backs” whenever possible. When a buyer charges merchandise the “brick and mortar” way, the merchant has an opportunity to obtain a signed voucher offering evidence that the cardholder received the merchandise and that he had participated in the transaction. In “brick and mortar” type transactions, the merchant can take steps to try to identify the cardholder as the person he holds himself out to be. But often the merchant depends on a cashier who is under time pressure and not highly trained or qualified to verify the identification of a purchaser. E-commerce transactions, almost always paid with credit cards, are usually charged back to a merchant when a cardholder claims a fraud occurred and refuses payment. This problem has grown so large that some merchants have claimed to experience losses from e-commerce charge backs that actually exceeded their successful sales.

### The Cost Is Borne By Consumers

The final price tag for these problems and abuses is ultimately borne by the consumer. In the final analysis, the consuming public bears the cost of each and every loss. They also bear all of the costs associated with the administration done by the credit card issuers (often to protect their own interests.). These costs are ultimately added to the price of the goods and services consumers purchase, or to the interest and other charges they pay for the privilege and convenience of paying with credit cards. Consumers also bear the cost of continual research and development done in efforts to find ways to better secure the infrastructure. Much of this expense finds its way into the monthly access charges people pay to their Internet service providers. As taxpayers, the public also pays the price tag associated with law enforcement and the penal system.

As the e-commerce explosion progresses, the costs of dealing with these problems could rapidly become prohibitive. E-commerce itself will suffer if too many cardholders become hesitant to transmit their account numbers over the public domain. This fear is bound to grow as the problems with security in cyberspace become more obvious to the public at large. Though millions of dollars are being invested into research for methods to better secure the infrastructure, gifted teenagers seem to be able to keep pace with (sometimes outwitting) the experts. So desperate is the security issue that job offers have come to youngsters who have illegally penetrated the computer networks of major corporations and even the U.S. Government. In terms of the credit card industry and their insurance carriers, a practical method of keeping the “honest people honest and the criminals away”, would be credible and highly valuable. The savings realized by merchants, consumers, and potentially law enforcement authorities could be so widespread and vast that it would be difficult to measure.

Both “brick and mortar” merchants and E-merchants could benefit from better means to confirm the identities of cardholders. With no chance of personal interaction with their buyers, E-merchants would derive a great deal of additional benefit if the orders they receive on line could be accurately validated. Consumers could also benefit from additional confidentiality associated with their credit card account numbers. Thus, there is a long felt but unsolved need to flexibly support credit card and other financial transactions over less-than-completely secure environments such as the Internet.

### SUMMARY OF THE INVENTION

The present invention provides, in accordance with one of its aspects, a concept that enables the complete processing of an e-commerce transaction without transmitting a credit card account number, or any other number that may be used by a merchant to authorize the transfer of funds. The invention thus provides techniques for enabling merchants and credit card issuers to do business with each other while retaining the customer's credit card account number within the domains of only a small number of entities, e.g. the cardholder, the card issuer, and an information clearing center that may belong to the card issuer or be separate of it.

Briefly, the present invention provides systems and methods that protect transaction information by not assembling it until after all transmissions through public domains have been completed. Each completed package of information (i.e., the information required before card issuers process transactions) is assembled from its components which are created and transmitted as the associated transaction progresses. None of these components (or pieces) of information has value in isolation because the assembly of components is needed to complete the transaction.

An e-commerce transaction may be initiated and proceed as a standard e-purchase. As such a transaction progresses, the purchaser may view it much in the same way as the transactions he is accustomed to, with only minor variations in the application procedure he experiences. As the purchaser steps through the purchase, various elements of information can be transmitted to different IP addresses over the Internet or other channel. There is no need to hide them beyond presently used standard Internet (e.g., “SSI” encrypted) connections.

In more detail, one aspect provided by the exemplary embodiments of the present invention supplies a method of conducting secure payment transactions between consumer and merchant comprising:

generating a unique transaction identifier associated with and identifying a transaction between the consumer and the merchant.

communicating said transaction identifier in lieu of the consumer's credit card account identifier;

authenticating said communicated transaction identifier;

associating the transaction identifier with the consumer's credit card account; and

effecting payment from the consumer to the merchant through use of said consumer's credit card account.

In some preferred example embodiments, the merchant generates said transaction identifier and communicates it to a third party transaction facilitator. The third party transaction facilitator may comprise an information clearing center and/or the issuer of said consumer's credit card account. The transaction identifier can be communicated over the Internet. Authentication may be based on a consumer pass code and/or a digital signature or other certification. The associating step may be performed after a database lookup.

In accordance with another aspect provided by the invention, a system for conducting secure payment transactions between consumer and merchant comprises:

equipment at the merchant that generates a transaction identifier associated with and identifying a transaction between the consumer and the merchant and communicates said transaction identifier to a transaction facilitator in lieu of the consumer's credit card account identifier;

equipment at the transaction facilitator that authenticates said communicated transaction identifier and associates the transaction identifier with the consumer's credit card account; and

payment fulfillment equipment that effects payment from the consumer to the merchant through use of said consumer's credit card account.

In preferred embodiments, merchants use a web server or other equipment and channels to generate said transaction identifier and communicate it to the transaction facilitator. The transaction facilitator may include a web server, a firewall, and an offline computer coupled to the web server through the firewall. The transaction facilitator may include a secure database that maps transaction identifiers and consumer pass codes into credit card account authorizations. The authenticating equipment may be responsive to digital signatures or other certifications.

The present invention thus provides a concept that enables processing of an e-commerce credit card transaction without transmitting the credit card account number that helps to solve or eliminates at least the following problems:

1. Preventing credit card information that is pirated, stolen, or simply lost from being used by criminals and unauthorized persons. The present invention provides a capability of squelching illegal and unauthorized use of credit card accounts. The capability is equally effective for Internet based and “in person” transactions and may be applied to either type.

2. Avoiding processing of credit card charges without sufficient verification of the transactions associated with those charges. Validation of the transactions is available as a result of “transactional evidencing.”

The present invention may also create a new obstacle and deterrence against those who would attempt certain criminal behavior.

The preferred embodiments of the present invention provide what can be called “PATH” (an acronym for “Payment Approval and Transactional History”). Unlike customary efforts to solve security breaches resulting in obtaining information fraudulently and illegally vis-a-vis the Internet, the exemplary embodiments of the present invention take advantage of already available technology to accomplish the full security and provide the currently unavailable assurance that is so badly needed to enable e-commerce transactions to take place with the highest level of safety. The preferred embodiments' mechanism solves the problem by removing it rather than trying to overpower it.

In accordance with one aspect of the invention, an operation is initiated when a transaction is processed. The operation may be engaged by the credit cardholder (the party rendering a payment) when he agrees to and engages in a transaction. For example, he may click an icon on his computer or other appliance (or another key if one is set up for the purpose). When used to assist with transactions conducted at a physical site, the site may have a card reader the customers may “swipe” or “dip” with their own credit cards, and a keypad that cardholders “punch” with their personal identifier codes when they are comfortable with the level of privacy available. To initiate a “telephonically” arranged transaction, the cardholder might “punch” his code on the keypad on his telephone, cell phone or other portable device. Before this takes place, the order taker (human or electronic procedure) may connect him to a circuit that is isolated from the order taker. Therefore it may be said that the cardholder or consumer is the primary operator and that a sales clerk, cashier, or order taker may sometimes assist the consumer by providing or connecting him with the controls used to make the system operate.

“Transactional Evidencing” provided by an aspect of the invention embodies a method of reliably and securely producing the following information at the time a transaction is initiated:

a. Evidence demonstrating that the purchaser is indeed the cardholder (or his agent) and not an imposter;

b. The cardholder's assertion that he has had the opportunity to review the order he placed and agreed to the purchase as confirmed by the merchant; and

c. Cardholder's assertion that he authorizes charges to be placed against his credit card.

In accordance with a further aspect of the preferred embodiments, the merchant is unable to unilaterally submit for payment; and only the cardholder is able to submit for payment of the merchant.

Currently, third party proxy service arrangements are often used as a shield by unsavory merchants as a means to continue relationships with card issuers that have terminated or otherwise do not approve of these merchants. Preferred embodiments of the present invention provide credit card issuers with the opportunity to retain their ability to know which merchants they are doing business with, and to exclude them if they wish. In the exemplary models, the customer requests payment—which effectively removes the kinds of problems that generally compel the issuers to exclude undesirable merchants in the first place.

Preferred embodiments of the invention offer additional advantages, such as for example:

I. Reliable Transaction Security & Squelching Unauthorized Credit Card Usage

Credit card issuers process electronic transactions for merchants they deal with. The exemplary embodiments of the invention allow them to process those transactions while keeping the credit card account information completely out of both public domains and domains controlled by the merchant. For example, method and apparatus can limit distribution of the cardholder's credit card number to only (a) the cardholder, and (b) the card issuer and/or an information clearing center where that cardholder has registered his information. As a result, in the exemplary embodiments, the invention effectively accomplishes the following:

A. Disables hackers who monitor the Internet with the intent of obtaining credit card information belonging to users of the invention.

B. Enables cardholders to make purchases with their card accounts without risk of pirates and hackers obtaining their account numbers.

C. Renders credit card information belonging the cardholders useless without their consent.

D. Prevents hackers from retrieving credit card information from merchants' servers and their databases.

E. Prevents merchants and their employees (present and previous) from placing unauthorized charges against a card account intentionally or by error.

F. In one embodiment, even if the physical card is lost, the card number will not enable unauthorized persons to use the account in person or electronically.

II. Transactional Evidencing

In addition, the preferred embodiments are able to supply credible evidence of each transaction. This type of information is useful to the credit card issuers when disputes arise, and also the merchants and cardholders. The transactional evidence can also be used to prevent and/or settle litigation. As one example, reliable transactional evidencing can be produced for transactions conducted over the Internet. By transactional evidencing, each exemplary embodiment accomplishes the following:

1. Produces Evidence Of The Purchaser's Intent To Purchase

Providing credible documented evidence of the cardholder's intent to purchase confirmed by the cardholder.

2. Produces Evidence Of The Validity Of The Order

Providing credible evidence to validate that the order was acknowledged and confirmed by the cardholder and may provide a description and/or other information concerning what was purchased. This confirmation is especially important if the payment is for a service or subscription that is delivered electronically because, unlike merchandise, no delivery receipt is returned to the merchant.

The exemplary embodiments of the present invention provide, in another aspect, a method of performing a financial transaction involving:

a credit card issuer that has issued a credit card to the purchaser

an information clearing center with:

1. a private credit card database, and

2. a web or other server to collect information that may be accessed by the private credit card database through an internal private connection;

a credit card with an associated credit card identifier such as a credit card account number (primary identifier) that is registered with the credit card database;

a purchaser of goods or services who possesses an additional identifier(s) (such as a personal password and/or customer ID #) that is registered with the credit card database (e.g., at the information clearing center and/or directly with the card issuer or its subsidiary or agent); and

a provider of goods or services

In accordance with this aspect of the invention, the merchant's invoice numbers or other identifiers take the place of the credit card account numbers to build a secure system of unique, one-session transactions while retaining card account numbers private. For example, when a transaction is agreed between a provider and the purchaser, the purchaser informs the provider that a preferred embodiment transaction facilitating entity such as a clearing center will be used to arrange payment, and does not pass his credit card account number to the provider. The purchaser communicates knowledge of the transaction to the transaction facilitating entity and passes the additional identifier(s) to it. The private credit card database retrieves the knowledge of the purchase and the purchaser's personal identifier ID. This may be done, for example, using a web server and an internal private connection. The private credit card database performs a mapping operation, using the purchaser's additional identifier(s) to link the knowledge of the transaction to the credit card's primary identifier. The information is then securely transmitted to the credit card issuer, or a clearing system of the credit card issuers. The credit card issuer arranges payment to the provider, who never obtains or receives the credit card's primary identifier (account #) or any ability to submit it for payment.

### BRIEF DESCRIPTION OF THE DRAWINGS

These and other features provided in accordance with the present invention will be better and more completely understood by referring to the following detailed description of presently preferred example embodiments in conjunction with the drawings of which:

FIG. 1 shows an overall example embodiment of the invention;

FIGS. 2a, 2b & 2c are example transaction flow diagrams;

FIGS. 3-7 are example information flow diagrams; and

FIG. 8 shows an example transaction system.

### DETAILED DESCRIPTION OF PRESENTLY PREFERRED EXAMPLE EMBODIMENTS

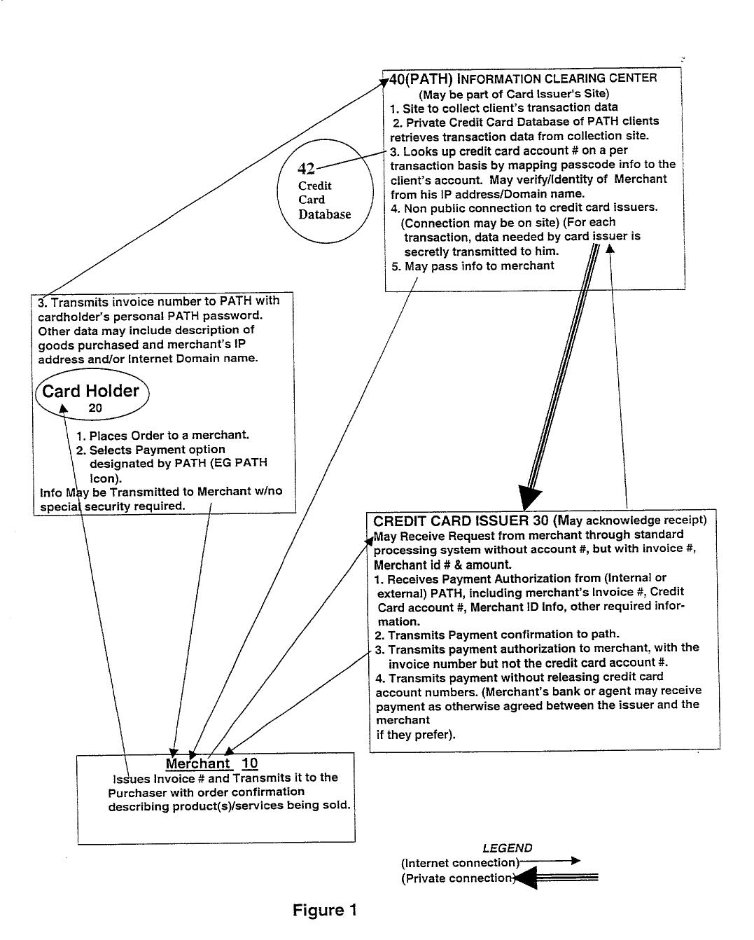

FIG. 1 shows an example embodiment of the invention. The diagram shows four example participants to a credit card transaction:

merchant 10,

card holder 20, and

a transaction facilitator entity 30 and/or 40.

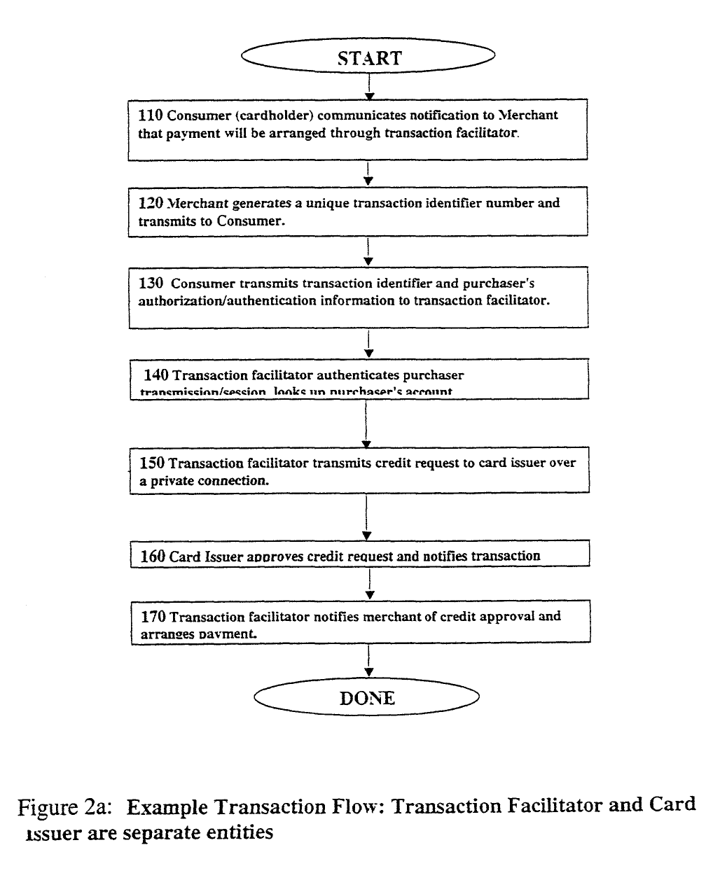

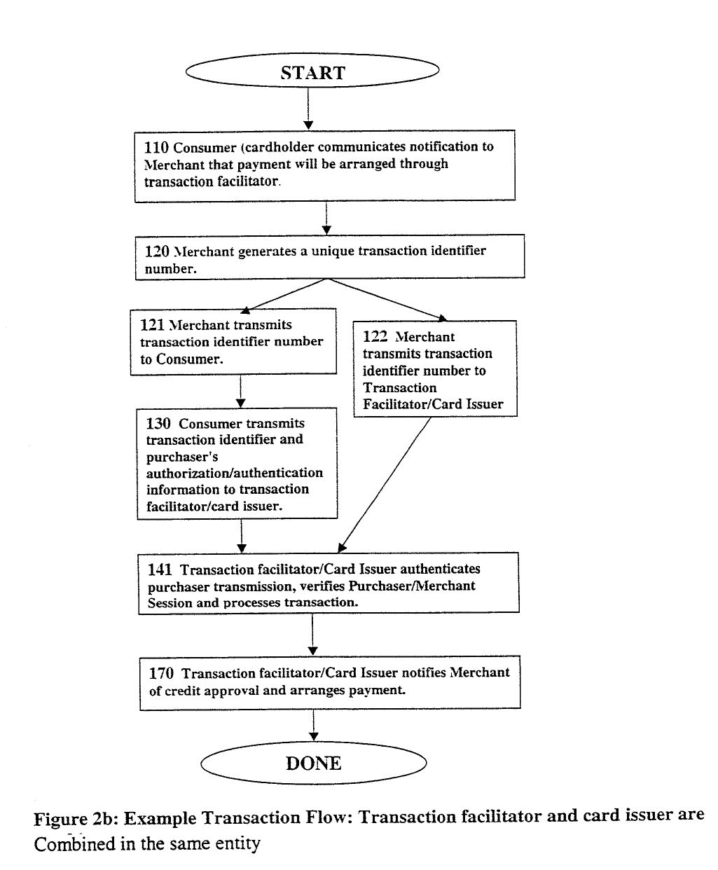

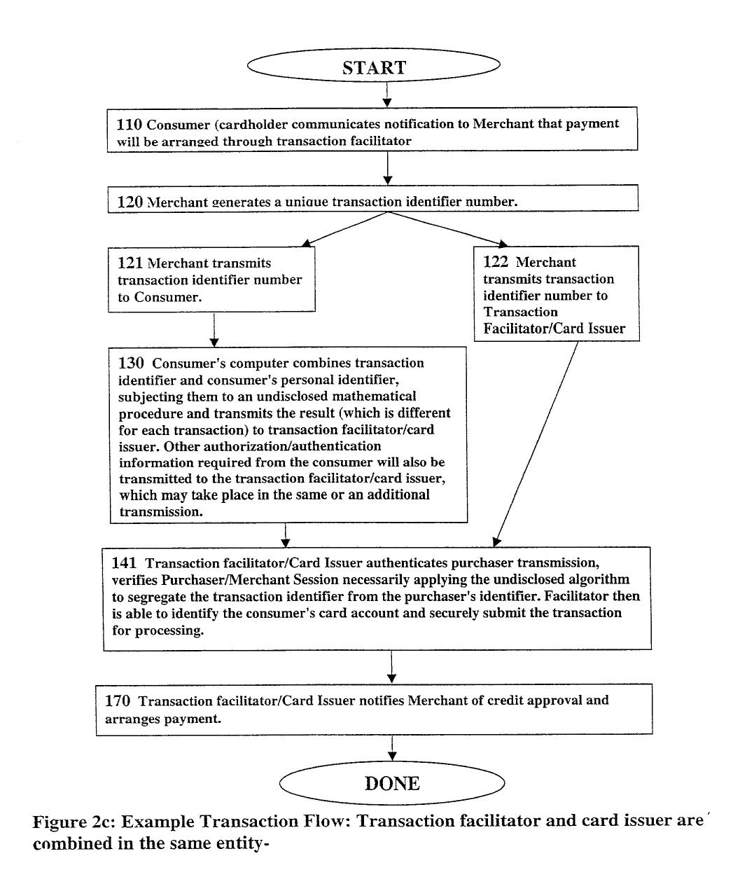

In the example embodiment, transaction facilitator entity 30 and/or 40 may comprise, for example, a credit card issuer 30 and/or an information clearing center 40 (which may, for example, be operated by a third party). In the example embodiment diagrammed in FIG. 2a, issuer 30 and clearing center 40 are separate entities. In the embodiments diagrammed in FIGS. 2b & 2c, they are the same entity, or one is the agent of or is otherwise associated with the other.

Internet connections, other types of digital or other communications connections, or others may be used to connect the merchant 10 with the card holder 20, the issuer 30 with the merchant 10, and the merchant 10 and/or the card holder 20 with the information clearing center 40. A secure connection (e.g., a private wire line or other secure communications link) preferably connects the information clearing center 40 with the credit card issuer 30.

To perform a transaction, a card holder 20 places an order with the merchant 10 and transmits a notification (such as a number or other identifier known to merchants and consumers, identifying a certain card issuer) in lieu of full credit card information. In at least one example embodiment, placing the order and transmitting the notification is performed via a server-client session over the Internet such as between a merchant 10 web server and a card holder's web browser. Since the notification is not confidential information (used simply to advise the merchant how payment will be processed), it can be transmitted over the Internet without taking any special security precautions (e.g., only standard Internet security levels such as SSL secure sessions or, in some embodiments, insecure sessions, are used or needed).

In response to the cardholder's order, the merchant 10 issues an identifier such as an invoice number with two components: a number or other value that identifies the merchant, and the merchant's own internal invoice number or other identifier. The merchant 10 transmits this information to the cardholder 20 with an order confirmation.

The cardholder 20 receives this information, and transmits the identifier (e.g., invoice number) to the information clearing center 40, which then requests the cardholder's personal identifier (e.g., his passcodes). These transmissions can be performed over the Internet in many examples. The payment information clearing center 40 may include a separate web site to receive transaction data from (cardholder/clients-20).

In preferred embodiments, the information clearing center 40 maintains a private credit card database 42 of all of its cardholder/clients. Each card-holder/client has personal identifier information and associated credit card number stored in the database 42. The credit card number identifies the client's credit card account, and can be used to place charges against his credit account. The private database 42 is highly secure, and is not accessible from the Internet in the exemplary embodiments.

When the information center's web server 40 receives from a cardholder 20 the invoice number and cardholder's personal identifier information (e.g., over the web via its web site), the information clearing center 40's private database 42 retrieves this information from the web server. The private database performs a mapping between the client's personal identifier information and his credit card account number. The private database 42 and associated computer may then electronically transmit information concerning the transaction to the card issuer 30—this information including the credit card account number. Since this information is highly confidential, the information clearing center 40 in at least one embodiment uses a highly secure communication channel (e.g., a private wire line or a telephone line not connected to the Internet and therefore immune to Internet hacking) to transfer the information to the card issuer 30. The information clearing center 40 may also pass other transaction information to the credit card issuer 30 (e.g., the merchant's invoice number, merchant identification information, amount to charge the credit card account, etc.).

When the card issuer 30 receives the payment authorization including the cardholder's credit card account number from the information clearing center 40, it may transmit a payment confirmation number back to the information clearing center 40. It further transmits a payment authorization to the merchant 10—which payment authorization includes the transaction identifier (i.e., merchant's invoice number) but not the credit card account information. The issuer 30 may also transmit payment to the merchant without releasing any credit card account numbers or other information.

As will be understood, in the preferred embodiment, the only transmission of the card holder 20's credit card number is from the information clearing center 40's private database 42 computer to the credit card issuer 30. This transmission is, in this example, via a highly secure connection that cannot be hacked. The credit card number is thus, in this example, never exposed to the merchant 10, but delivered to the card issuer without exposure to the Internet'and is never transmitted over the Internet in this specific example—even though most of the transaction may take place over the Internet. Thus, the exchanges between the merchant and the cardholder is similar to the methods they are used to, but the variations provide a new level of security—and the basis on which payments are exchanged in these kinds of transactions has been recreated into a new form to provide a security level that never before was available.

### More Detailed Example Embodiments

FIGS. 2a, 2b, & 2c: TRANSACTION FLOW DIAGRAMS

2a: Transaction Facilitator is only an information clearing center, a separate entity from any card issuer.

2b: Transaction Facilitator is an entity wherein the information clearing center and a specific card issuer are combined in a single entity.

2c: Transaction Facilitator is an entity wherein the information clearing center and a specific card issuer are combined in a single entity. This embodiment discloses a method of cloaking the consumer's identifying information by combining it with the each new transaction identifier.

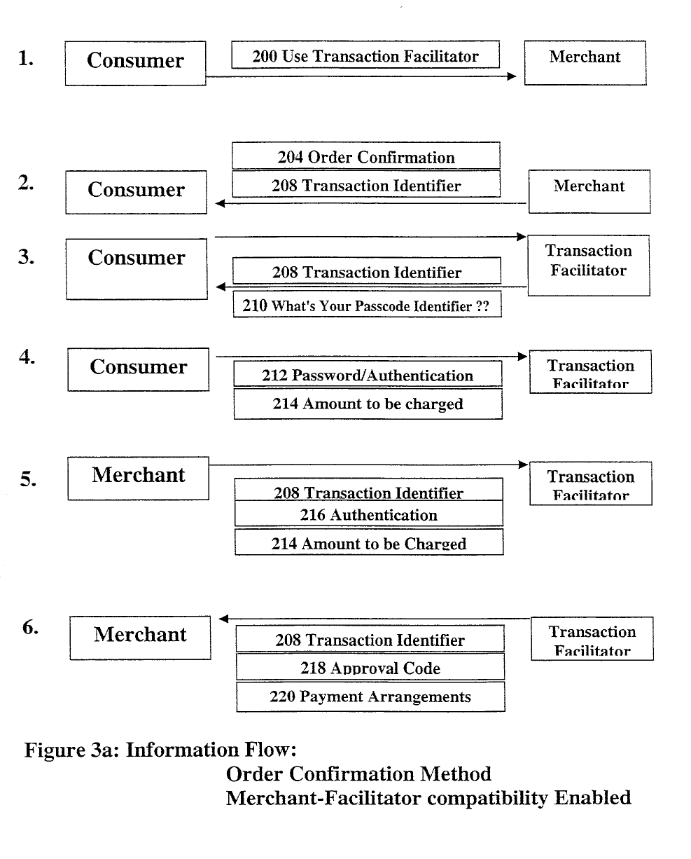

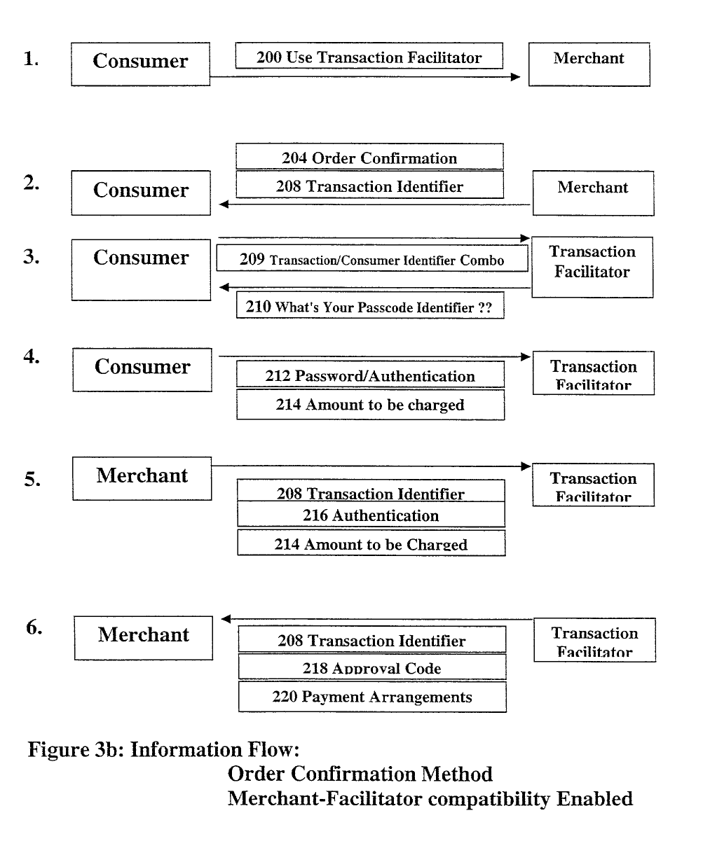

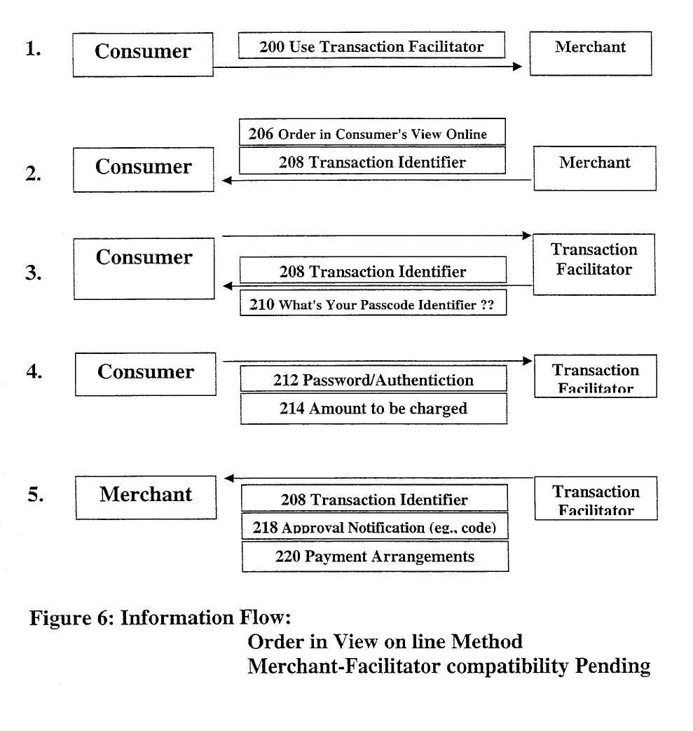

FIGS. 3a-7: EXAMPLE TRANSACTIONS-INFORMATION FLOW DIAGRAMS

FIGS. 3a,3b,5,7: Merchant communication/transaction processing is compatible with transaction facilitator. (eg: Merchant's transaction software has been programmed to perform functions of the invention in communication with a particular transaction facilitator who may also be an issuer for a particular brand of credit cards. If facilitator is a card issuer, merchant will preferably favor the same brand as the trans-action facilitator.

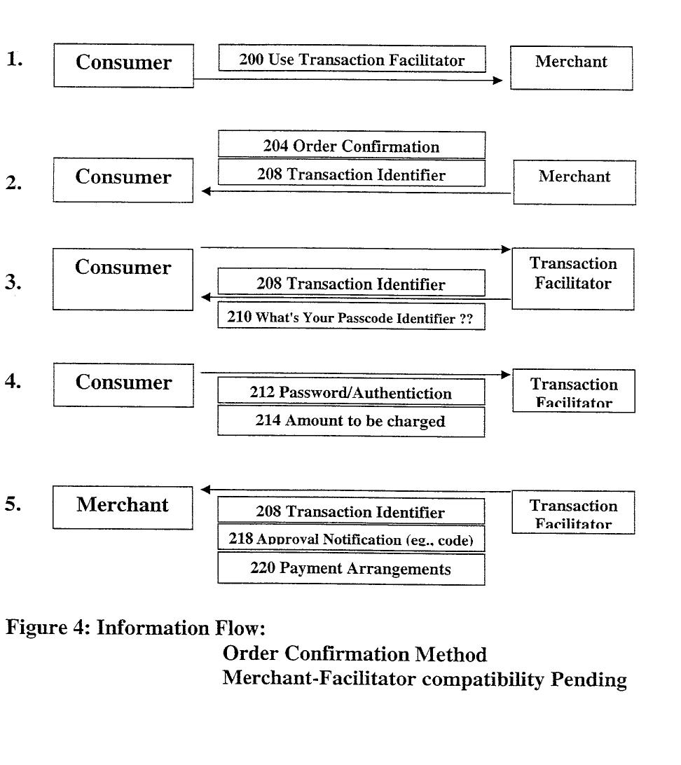

FIGS. 4,6: Merchant is not programmed to communicate with a transaction facilitator, but is able to participate with a consumer to process a transaction, transmitting the necessary transaction identifier to him.

FIGS. 3a,3b,4: Internet “PC” Type Transaction: Transactional evidence; Customer's affirmation based on his review of order confirmation sent by merchant (eg: by email).

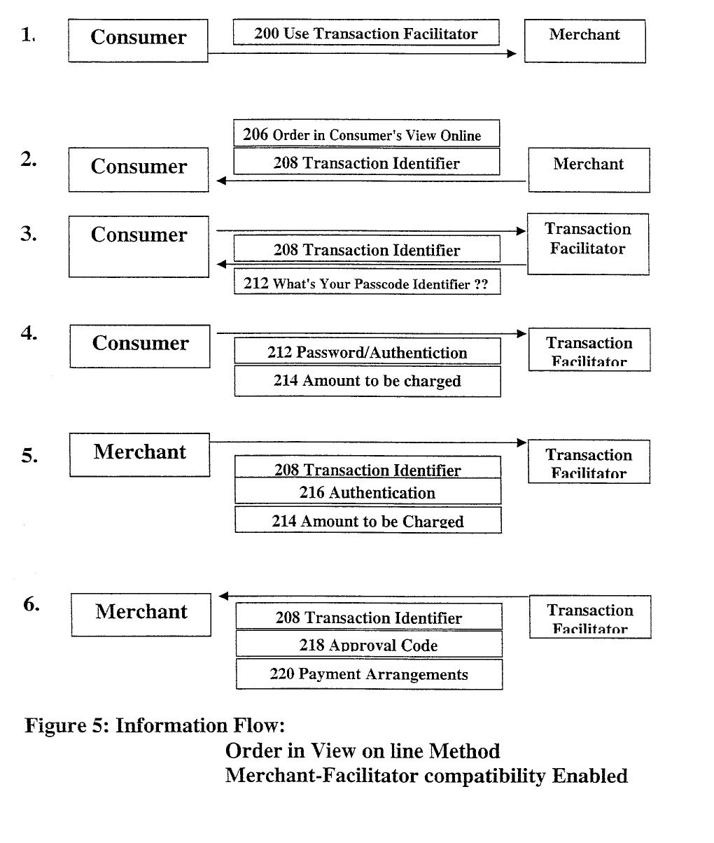

FIGS. 5,6: Internet “PC” Type Transaction: Transactional evidence; Customer's affirmation based on his review of order which is displayed to him on line after he places the “buy” order (e.g., after he clicks “buy”, before he clicks “oktopay”)

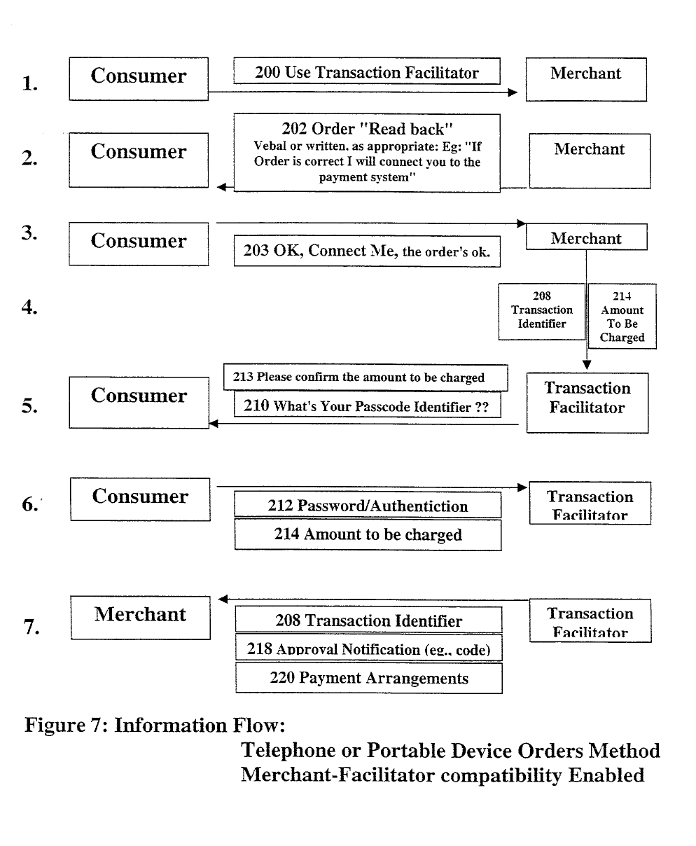

FIG. 7: Telephone, cell phone, other portable devices used to place orders or affect payment: Transactional evidence; Customer's affirmation based on a verbal request or an order “read back” for verbal orders, or in writing for portable devices.

In each of the above disclosed embodiments, transactions proceed according to its specific outline and at the same time, following the overall flow depicted in FIG. 1.

The example transactions proceeds as follows:

1. The consumer 20's credit card account will never be transmitted to the merchant in these examples. Instead, the consumer will transmit a notification 200 (e.g., identifying information known to both the merchant and the consumer) to the merchant that payment will be arranged by a transaction facilitating entity 30, 40 (FIGS. 2a,2b, & 2c block 110) such as for example an information clearing center.

2. The merchant 10 will transmit to the consumer 20 an order confirmation 204 (or an online view or read back of the completed order 206 or 202 respectively) with a transaction identifier 208 (such as a number that may be included in the invoice number), which discloses the identity of the merchant (FIG. 2, block 120). In so-called “brick and mortar” transactions that use a physical point of purchase as opposed to a virtual one, the merchant can transmit (e.g., over the Internet, telephone lines, or other communications means) the customer identifier from a card swiper or other transaction equipment along with a transaction identifier (which might be supplied for example from an electronic cash register to the card swiper). In such an arrangement, the merchant is prevented from recording the consumer's credit card account information.

3. If the consumer 20 agrees to the order confirmation, he will make his final Internet transmission 212 to the information clearing center 40 (FIGS. 2a,2b & 2c, block 130). In some example embodiments, this probably will not even occur at the time he placed the order because many merchants require time before they send consumers order confirmations, and the consumer may require time to review the confirmation. In other examples, it will not occur at the same moment due to brief time lapses between the time the consumer 20 places the order and the additional steps he takes to initiate the payment. In such embodiments, the consumer's final Internet transmission will serve as his affirmation that he has reviewed the merchant's confirmation and is in agreement with the transaction.

In the examples shown, the final Internet destination of all elements transmitted by the client 20 of the information created by a transaction is the information clearing center 40 (the card issuer 30 if combined with the information clearing center 40). Consumers 20 can be clients of the information center 40. They will transmit information to the center 40, including for example:

a. Transaction identifier 208 (e.g., the merchant's 10 combined invoice/ID #) or 209 (e.g., a combined transaction/personal id);

b. A password or other authentication value 212 associated with or chosen by the consumer 20;

c. The amount to be charged to consumer's credit card 214; and/or

d. A personal ID code previously registered with the information center 40.

4. An identifier may also be stored on the consumer's computer by the information center 40 (for example, a digital “certificate” is one way to identify a sending computer) (FIGS. 2a block 140 & 2b block 141). The identifying information may be dynamically assigned (for example, by assigning a new number in each session and used by the information clearing center 40 to identify cardholder/client 20's computer the next time there is a session). As one example, this cardholder/client 20's computer's dynamically assigned ID # may be transmitted with the client's identifier information when he requests that a payment be arranged from his credit card.

Clients of the information clearing center may transmit these requests by performing an operation such as for example clicking an icon on the screen of an Internet or other network capable appliance when a confirmation invoice or online order form is in view.

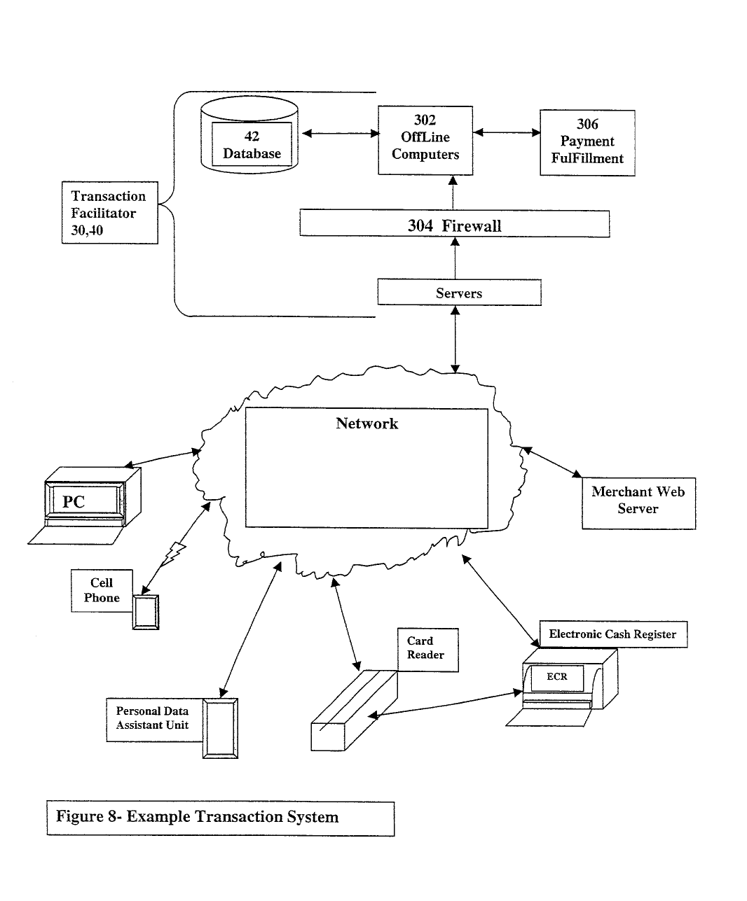

As the elements of information are collected by the information clearing center 40, they are removed from the public domain. Then they are assembled by the center's “off line” computers 302 (see FIG. 8), which in at least one example are not web servers and are not accessible from the Internet. In at least one example embodiment, the information center 40 permits the off line computers 302 to retrieve the information identifying the client from its web site via a back-end connection routed through a firewall 304, or another method they deem appropriate to give the off-line computer specific immunity from hackers and pirates. The off-line computers contain a database 42 where the accounts of the clients are registered and stored. The identifier supplied by the client 20 is then mapped to his credit card information by a database 20 lookup done by the off-line computer 302. The information of the transaction is packaged by the off-line computer and transmitted to the card issuer 30 by a payment fulfillment process 306 (or used directly if the information clearing center 40 and the credit card issuer 30 are the same entity) or to a clearing system shared by multiple card issuers over a “tamperproof” connection (for example, not connected to the Internet at all). Since the Internet is not involved in this transmission in these illustrative examples, the information is kept secure and is not vulnerable or at risk. The merchant will never see it, nor will any else except the information center 40 and/or the credit card issuer 30 who maintain the information in secure locations.

5. The merchant 10 may be notified directly by the credit card issuer of the approval (or decline) of the credit. The communications medium used may be the one in place already (the card processing system), because no credit card account number will be transmitted by or to the merchant 10. In the examples illustrated in FIGS. 3-7, he will receive a message 216 including the following in their respective illustrative embodiments:

a. His own transaction identifier 208 (e.g., invoice and/or merchant ID number) for identification of each transaction; and

b. Standard approval code and payment arrangements 218, 220, absent the unique part of each card's account number (e.g., only the Card Issuer 30 revealing portion of the number will be displayed to the merchant).

### Underlying Theory

Picturing public domain (i.e., the Internet) as a domain where major battles are being fought against information piracy (the battleground), a battle would not be fought if the target (information) could be kept away from the battleground and hidden out of view. Information is a moving target. It is transmitted across the Internet in packages known as packets. Experts in Internet security have placed much focus on building better ways to package and code the information while it is transmitted through public domain (e.g., data encryption). While better coding methods are helpful and purposeful, this approach, used by itself, contains inherent shortcomings:

1. The information can still be decoded. Throughout history, no matter what methods or technologies have been developed to code information, ways have been found to “crack” the codes. While some of the computer generated codes of modern times are very good, the problem remains.

2. Even if the information were transmitted in a format that could not be deciphered, generally accepted methods and procedures used to process on-line transactions result in the passing of sensitive information to places where it is vulnerable and accessible by persons who have no actual need for it. This poses a risk in every case involving transmission of information useable by the bearer to submit for payment.

The preferred embodiments of the present invention embody two theories. The first theorizes about the substance of information, saying that information consists of components that may be disassembled and reassembled, and that without all of these components assembled correctly the information loses its meaning. An analogy would be to say that information is like an aircraft, which is also assembled from components, such as the wings, the engines, and the fuel tanks. If any of these components is missing or incorrectly installed, the aircraft is essentially useless, unable to serve the purpose for which it exists.

The second is based on the fact that information can't be abused by anybody who doesn't have it. If transactions involving the use of information (e.g., credit card account information) can be processed without revealing the critical portions of that information (e.g.: card account numbers and the identities of the cardholders) to anybody who didn't have it before the transaction was initiated, and without storing it in places where it was not stored before the transaction was initiated, then whatever level of security that existed before the transaction took place will not be compromised as a result of the transaction being processed.

Since each payment request in the exemplary embodiment involves submitting information during an interactive session, there is provided an inherent deterrent to the “mass production” methods of sophisticated fraudsters. Results oriented criminals will prefer to avoid this system, because it is designed to defeat the efficiencies they require to operate profitably even if they could know the pass codes and other information they would require. “Small time” fraudsters will tend to avoid it also. Their perceived risk of capture increases as they realize they are communicating interactively with multiple parties, registering information into their computers and accepting messages from those they wish to cheat.

While the invention has been described in connection with what are presently considered to be the most practical and preferred embodiments, it is to be understood that the invention is not to be limited to the disclosed embodiments. On the contrary, the invention is intended to cover various modifications and equivalent arrangements included within the scope of the appended claims. For example, the information center may be installed at the site of a credit card issuer or even be transferred or assigned to such issuer. As another example, the invention shall include new methods/technologies (e.g., advances in Internet and networking security) as they become available.

I claim:

1. A method of performing a financial transaction involving at least: (a) a provider of goods or services, (b) a purchaser of said goods or services, and (c) at least one further entity, the purchaser using a credit card having a credit card identifier associated therewith to effect a purchase of said goods or services, the method including:
performing at least one transaction between the provider and the purchaser;
associating at least one identifier different from the credit card identifier with said transaction;
communicating the transaction identifier but not the credit card identifier from the purchaser to the further entity over the Internet;
associating the transaction identifier to the purchaser's credit card identifier,
whereby the credit card issuer charges the purchaser's credit card based at least in part on the associated credit card identifier.

2. A method as in claim 1 further including transmitting the purchaser's credit card identifier over a private connection.

3. A method as in claim 1 wherein the communicating step includes transmitting pieces of information at different times to different locations.

4. A method of making charges for goods and/or services against the account of a payment card having an associated account number, including paying a provider of goods and/or services, without supplying the account number to the provider of said goods and services.

5. A method of providing transactions while providing uniqueness for each transaction, including relying on transactional identifying system generated by combining providers'identification numbers with their internal invoice numbers for each transaction.

6. A method of conducting payment transactions between consumer and merchant comprising:
generating a transaction identifier associated with and identifying a transaction between the consumer and the merchant;
communicating said transaction identifier in lieu of the consumer's credit card account identifier;
authenticating said communicated transaction identifier and those who transmit it;
associating the transaction identifier with the consumer's credit card account; and
effecting payment from the consumer to the merchant through use of said consumer's credit card account.

7. The method of claim 6 wherein the consumer communicates the transaction identifier.

8. The method of claim 6 wherein said merchant generates said transaction identifier and communicates it to a third party transaction facilitator.

9. The method of claim 8 wherein said third party transaction facilitator comprises a clearinghouse.

10. The method of claim 8 wherein said third party transaction facilitator comprises the issuer of said consumer's credit card account.

11. The method of claim 6 wherein said communicating step comprises communicating said transaction identifier over the Internet.

12. The method of claim 6 wherein said authenticating step is based on a consumer passcode.

13. The method of claim 6 wherein said authenticating step is based on a digital signature.

14. The method of claim 6 wherein said associating step is performed based on a database lookup.

15. The method of claim 6 further including the steps of:
combining the transaction identifier and consumer's personal identifier,
subjecting the combined transaction identifier and consumer's personal identifier to an undisclosed mathematical procedure, and
transmitting the result of said procedure,
wherein the authenticating step is based at least in part on the transmitted result.

16. A system for conducting secure payment transactions between consumer and merchant comprising:
equipment at the merchant that generates a transaction identifier associated with and identifying a transaction between the consumer and the merchant and communicates said transaction identifier to a transaction facilitator in lieu of the consumer's credit card account identifier;
equipment at the transaction facilitator that authenticates said communicated transaction identifier and associates the transaction identifier with the consumer's credit card account; and
payment fulfillment equipment that effects payment from the consumer to the merchant through use of said consumer's credit card account.

17. The system of claim 16 wherein said merchant uses a web server to generate said transaction identifier and communicate it to the transaction facilitator.

18. The system of claim 16 wherein said transaction facilitator includes a web server, a firewall, and an offline computer coupled to the web server through the firewall.

19. The system of claim 16 wherein said merchant uses an electronic cash register to generate said transaction identifier.

20. The system of claim 16 wherein said transaction facilitator includes a secure database that maps transaction identifiers and consumer passcodes into credit card account authorizations.

21. The system of claim 16 wherein said authenticating equipment is responsive to digital signatures and certificates.
